(19) United States
(12) Patent Application Publication
(10) Pub. No.: US 2020/0376730 A1
(43) Pub. Date: Dec. 3, 2020

(54) RESIN MOLDED ARTICLE

(71) Applicant: Sumitomo Wiring Systems, Ltd., Yokkaichi-shi, Mie (JP)

(72) Inventors: Koichi Kato, Yokkaichi-shi, Mie (JP); Kyungwoo Kim, Yokkaichi-shi, Mie (JP)

(21) Appl. No.: 16/770,215

(22) PCT Filed: Nov. 22, 2018
(86) PCT No.: PCT/JP2018/043219

§ 371 Date: Jun. 5, 2020

(30) Foreign Application Priority Data
Dec. 6, 2017 (JP) 2017-234021

(51) Int. Cl. B29C 45/14; B29C 45/26; G01P 1/02

(52) U.S. Cl. CPC B29C 45/14598; B29C 45/14639; G01P 1/02; B29C 45/26

(57) ABSTRACT

A resin molded article includes a primary molded portion made from a synthetic resin material and a wire of which a front end portion is embedded in the primary molded portion. A sensor is connected to the front end portion of the wire, and is arranged such that the sensor is partially exposed from an outer surface of the primary molded portion. A seal member has a tubular shape and is in liquid-tight areal contact with a region of an outer periphery of the primary molded portion that is rearward of the exposed portion of the sensor. A secondary molded portion is in liquid-tight areal contact with an outer periphery of the seal member, and encases at least an entire region of the primary molded portion that is forward of the seal member.

### CROSS-REFERENCE TO RELATED APPLICATIONS

This application is the U.S. national stage of PCT/JP2018/043219 filed on Nov. 22, 2018, which claims priority of Japanese Patent Application No. JP 2017-234021 filed on Dec. 6, 2017, the contents of which are incorporated herein.

### TECHNICAL FIELD

The present disclosure relates to a resin molded article.

### BACKGROUND

A technique is conventionally known in which, after a primary molded inner component is set into a metal mold, a secondary molded component is molded by filling the metal mold with a resin material in a molten state, thus producing a resin molded article. As an example, JP 2005-7715A discloses a technique in which a synthetic resin plate (inner component) is set into a metal mold, and the metal mold is filled with a resin material in a molten state in order to mold an exterior body (secondary molded portion). The outer surface of the plate is provided with a melt-rib that is triangular in a cross-sectional view thereof and has a pointed leading end. When the metal mold is filled with the resin material in a molten state, the leading end side of the melt-rib melts into the resin material, and this melted portion hardens after having melted together with the resin material. In this way, the leading end of the melt-rib can be formed with a seal portion that is in areal contact with the plate and the exterior body, and thus liquid can be prevented from entering by the seal portion.

With the resin molded article described above, in an environment such as a shock test that includes repeated and rapid heating and cooling, a difference in temperature occurs between the resin body of the inner component and the resin body of the secondary molded portion, and stress tends to become concentrated in the portion of the leading end of the melt-rib that is in areal contact with the plate and the exterior body. That is to say, the temperature of the resin molded article rises from the outer portion first when heated and falls from the outer portion first when cooled, and therefore a difference in temperature occurs between the resin body of the inner component and the resin body of the secondary molded portion, and the level of strain may be different between the resin body of the outer portion and the resin body of the secondary molded portion. Thus, stress becomes concentrated on the portion of the leading end of the melt-rib that is in areal contact with the plate and the exterior body. If such stress is repeatedly applied to the leading end of the melt-rib, there is a concern that the portion of the leading end of the melt-rib that is in areal contact with the plate and the exterior body may eventually break and cause a gap to form between the inner component and the secondary molded portion, and that liquid may enter through this gap.

The present disclosure was completed based on circumstances such as those described above, and an object thereof is to improve the reliability of sealing performance.

### SUMMARY

The present disclosure relates to a resin molded article having a primary molded portion made from a synthetic resin material and a wire of which a front end portion is embedded in the primary molded portion. An electronic component is connected to the front end portion of the wire in the primary molded portion, and is arranged such that the electronic component is partially exposed from an outer surface of the primary molded portion. A seal member that has a tubular shape and is in liquid-tight areal contact with a region of an outer periphery of the primary molded portion that is rearward of the exposed portion of the electronic component. A secondary molded portion that is in liquid-tight areal contact with an outer periphery of the seal member encases at least an entire region of the primary molded portion that is forward of the seal member.

### Advantageous Effects

The seal member seals the gap between the outer periphery of the primary molded portion and the inner periphery of the secondary molded portion in a liquid-tight state, and because the seal member has a tubular shape, the sealed region between the primary molded portion and the seal member, and the sealed region between the seal member and the secondary molded portion are maintained for a long time in the front-rear direction. Accordingly, the sealing performance is improved.

### BRIEF DESCRIPTION OF DRAWINGS

FIG. 1 is a perspective view of a resin molded article of a first embodiment.

FIG. 2 is a perspective view of a primary molded module.

FIG. 3 is a cross-sectional diagram showing a state in which a coated wire, a sensor, and a seal member are set in a metal mold for primary molding.

FIG. 4 is a cross-sectional view of a primary molded module in which the primary molded portion, the coated wire, the sensor, and the seal member form a single body.

FIG. 5 is a cross-sectional diagram showing a state in which the primary molded module is set in a metal mold for secondary molding.

FIG. 6 is a cross-sectional diagram showing a state in which the secondary molded portion is molded and formed as a single body with the primary molded module.

### DETAILED DESCRIPTION OF PREFERRED EMBODIMENTS

The seal member of the present disclosure may be made from a synthetic resin material that has a lower melting point than that of the synthetic resin material from which the primary molded portion is made. With this configuration, in the primary molding step in which a metal mold is used, the inner peripheral surface of the seal member is melted by the heat of the molten resin material of the primary molded portion, and it is thus possible to weld the inner peripheral surface of the seal member to the outer peripheral surface of the primary molded portion.

The seal member of the present disclosure may be made from a synthetic resin material that has a lower melting point than that of the synthetic resin material from which the secondary molded portion is made. With this configuration, in the secondary molding step in which a metal mold is used, the outer peripheral surface of the seal member is melted by the heat of the molten resin material of the secondary molded portion, and it is thus possible to weld the outer peripheral surface of the seal member to the inner peripheral surface of the secondary molded portion.

The material of the seal member of the present disclosure may also be urethane resin. With this configuration, the seal member breaking is not a concern even if the outer periphery of the primary molded portion and the inner periphery of the secondary molded portion become displaced in the front-rear direction.

### First Embodiment

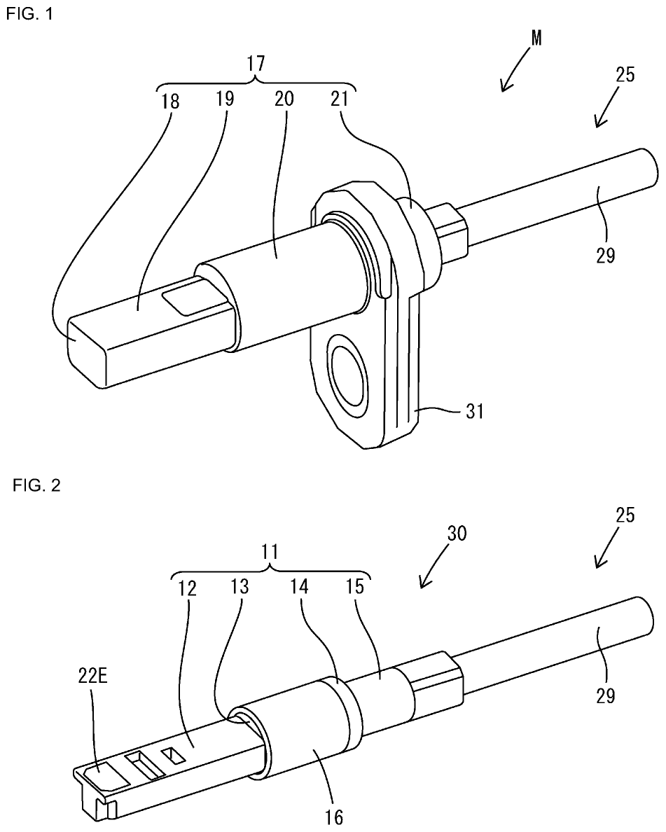

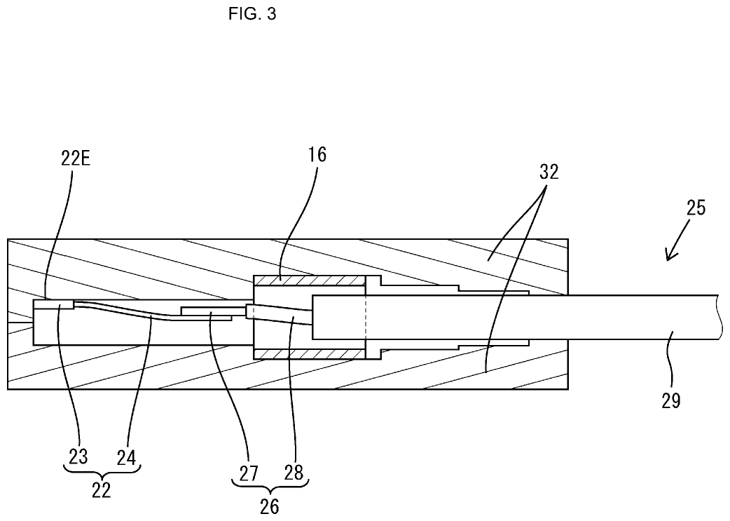

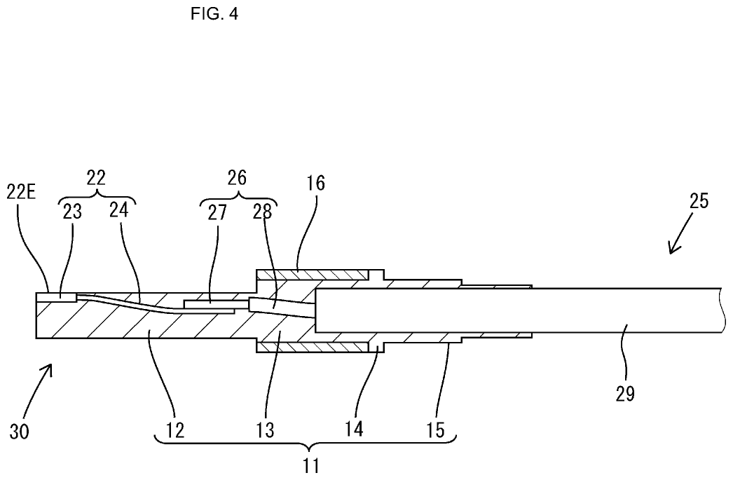

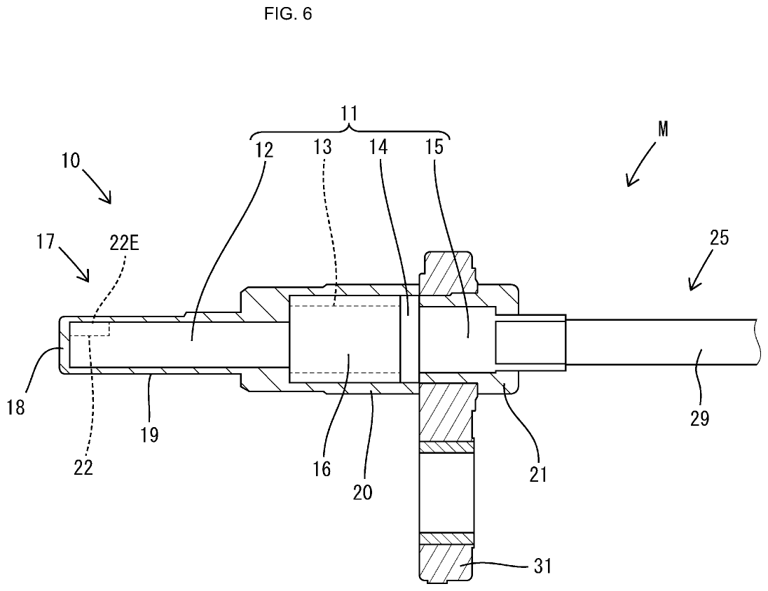

The following describes a first embodiment of the present disclosure with reference to FIGS. 1 to 6. Note that the front-rear direction in the following description is defined with leftward in FIGS. 1 to 6 being forward. The up-down direction is defined with upward and downward as they appear in FIGS. 1 to 6.

A resin molded article M of the first embodiment functions as an automotive sensor that is installed in a vehicle, and specifically as a vehicle wheel speed sensor that is used to measure the rotational speed of the wheels of a vehicle. The resin molded article M is fixed to a vehicle and faces a rotor that rotates integrally with the wheels of the vehicle. The resin molded article M includes a holder 10 that is made from a synthetic resin, a sensor 22 (described as an “electronic component” in the claims), a wire harness 25, and a bracket 31 that is made of a metal. The bracket 31 functions as a means for attaching the resin molded article M to the body of a vehicle.

The sensor 22 includes a sensor body 23, and a pair of left and right connection terminals 24 that extend rearwardly from the sensor body 23 in a cantilever shape. The sensor body 23 includes a detection element (not shown) that detects the physical amount (change in magnetic field) of a target object and converts this detection result into an electrical signal. The sensor body 23 is formed with an overall plate-shape by liquid-tightly sealing a detection circuit (not shown) including the detection element with a molded resin material. The whole sensor 22 is embedded into the holder 10 through insert molding. When the resin molded article M is fixed to a vehicle, the sensor body 23 is arranged facing the outer peripheral surface of the rotor (not shown) of the wheel. The sensor body 23 converts the change in the magnetic field that occurs with the rotation of the rotor into an electrical signal, and outputs the obtained electrical signal to the wire harness 25 via the connection terminals 24.

The wire harness 25 is one wire that is formed from two coated wires 26 (described as wires in the claims) that are collectively coated with a resin coating 29 or the like. The coated wires 26 have a commonly known configuration in which a conductive wire 27 is encased in an insulating coating 28. The front end portions of the two coated wires 26 have a portion of the insulating coating 28 removed therefrom, therefore exposing the front end portions of the conductive wires 27. The exposed portions of the two conductive wires 27 are individually connected to the pair of connection terminals 24 through soldering. The rear end portion of the wire harness 25 is connected to a control apparatus (not shown) that is installed in a vehicle. The control apparatus calculates the wheel speed of the vehicle in accordance with the output signal from the sensor 22 and performs control of an ABS (Anti-lock Brake System) or the like.

The holder 10 includes a primary molded portion 11, a seal member 16, and a secondary molded portion 17, and has an overall shape that is thin and long in the front-rear direction. The primary molded portion 11 is made from a polyamide resin (PA) that contains glass, and has an overall shape that is thin and long in the front-rear direction. The primary molded portion 11 includes a component housing portion 12 that is formed at the front end portion of the primary molded portion 11, a seal function portion 13 that extends rearwardly from the rear end of the component housing portion 12, an enlarged diameter portion 14 that is adjacent to the rear end of the seal function portion 13, and an electrical wire holding portion 15 that extends rearwardly from the enlarged diameter portion 14.

The cross-sectional shape of the component housing portion 12 is substantially rectangular when cut perpendicular to the axis thereof in the front-rear direction. The cross-sectional shape of the seal function portion 13 is circular when cut perpendicular to the axis thereof in the front-rear direction. The enlarged diameter portion 14 has a larger outer diameter than that of the seal function portion 13, and has a flange-shape that is concentric with the seal function portion 13. The cross-sectional shape of the electric wire holding portion 15 is circular when cut perpendicular to the axis thereof in the front-rear direction.

The front end portions of the sensor 22 and the wire harness 25 (the two coated wires 26) are formed as a single body with the primary molded portion 11 through insert molding. The whole of the sensor 22 including the sensor body 23 and the connection terminals 24 is embedded in the component housing portion 12 and is arranged forward of the front end of the seal function portion 13. The exposed conductive wires 27 (the connecting portions of the sensor 22 and the connection terminals 24) at the front end portion of the wire harness 25 are arranged in the component housing portion 12. The region of the front end of the wire harness 25 that is rearward of the portion thereof that connects to the sensor 22 is embedded in the seal function portion 13, the enlarged diameter portion 14, and the electrical wire holding portion 15.

When the primary molding process has finished and the primary molded portion 11 is molded, the upper surface of the sensor body 23 (an exposed portion 22E of the sensor 22) is flush with and exposed from the upper surface (outer surface) of the component housing portion 12. The upper surface (the exposed portion 22E) of the sensor body 23 is the only part of the sensor 22 that is exposed from the outer surface of the primary molded portion 11, and the other parts of the sensor body 23 other than the upper surface thereof are embedded in the primary molded portion 11. Also, the wire harness 25 is led out rearwardly from the rear end surface of the primary molded portion 11 (the electrical wire holding portion 15) in an exposed state. The primary molded portion 11, the sensor 22, and the front end portion of the wire harness 25 constitute a primary molded module 30.

The seal member 16 is made from a urethane resin material and has a round, tubular shape that has a predetermined length in the axial direction (front-rear direction) thereof. The seal member 16 is formed as a single body with the primary molded portion 11 though insert molding. The seal member 16 is in liquid-tight areal contact with the outer peripheral surface of the seal function portion 13 across the entire length of the seal member 16. The outer diameter of the seal member 16 is approximately the same as the outer diameter of the enlarged diameter portion 14. The rear end surface of the seal member 16 is in liquid-tight areal contact with the front end surface of the enlarged diameter portion 14. The melting point of the material that the primary molded portion 11 is made of, which is polyamide resin that contains glass, is approximately 240° C., whereas the melting point of the material that the seal member 16 is made of, which is urethane resin, is approximately 200° C. In other words, the seal member 16 is made from a resin material that has a lower melting point than that of the resin material from which the primary molded portion 11 is made.

Similar to the primary molded portion 11, the secondary molded portion 17 is made from a polyamide resin (PA) that contains glass, and is formed as a single body with the primary molded module 30 by insert molding with the use of a metal mold for secondary molding 33. The secondary molded portion 17 is long and thin overall in the front-rear direction, and has a bottomed cylindrical shape of which the front end portion is closed off. The secondary molded portion 17 includes a front wall portion 18 that is formed on the front end portion of the secondary molded portion 17, a tubular front portion external cover 19 that extends rearwardly from the outer circumferential edge of the front wall portion 18, a tubular middle portion outer cover 20 that extends rearwardly from the rear end of the front portion external cover 19, and a tubular rear portion external cover 21 that extends rearwardly from the rear end of the middle portion outer cover 20.

The front wall portion 18 is in areal contact with the front end surface of the component housing portion 12 of the primary molded portion 11. The front portion external cover 19 covers the entire region of the outer peripheral surface of the component housing portion 12 in a state of areal contact, and also covers the exposed portion 22E of the sensor 22 in a state of areal contact. The outer periphery of the rear end portion of the front portion external cover 19 is diametrically enlarged in a flange-shape. The middle portion outer cover 20 extends rearwardly from the flange-shaped portion of the outer periphery of the rear end portion of the front portion external cover 19. The middle portion outer cover 20 covers the entire region of the outer peripheral surface of the seal member 16 in a state of liquid-tight areal contact, and also covers the entire region of the outer peripheral surface of the enlarged diameter portion 14 in a state of areal contact. The rear portion external cover 21 covers the front end side region of the outer peripheral surface of the electric wire holding portion 15 in a state of areal contact.

The following will describe the method with which the resin molded article M of the first embodiment is produced. First, as shown in FIG. 3, the front end portion of the wire harness 25 and the sensor 22 are in a connected state and set into a metal mold for primary molding 32. Likewise, the seal member 16 is also set into the metal mold for primary molding 32. At this time, the exposed portion 22E of the sensor body 23 abuts the metal mold for primary molding 32 in a state of surface contact, and the entire region of the outer peripheral surface of the seal member 16 also abuts the metal mold for primary molding 32 in a state of surface contact. In this state, a molten polyamide material that contains glass (hereinafter referred to as “molten resin material for primary molding”), which is the material from which the primary molded portion 11 is made, is injected into the metal mold for primary molding 32.

The temperature of the molten resin material for primary molding (polyamide resin that contains glass) to be injected into the metal mold is higher than 240° C., which is higher than the melting point for urethane resin from which the seal member 16 is made. Due to this difference in temperature, the inner peripheral surface and the rear end surface of the seal member 16 that are in contact with the molten resin material for primary molding melt, and the melted portions of the seal member 16 melt together with and form a single body with the molten resin material for primary molding. Note that the entire region of the outer peripheral surface and the front end surface of the seal member 16 do not melt because said surfaces are in direct contact with the metal mold for primary molding 32 of which the temperature thereof is lower than that of the molten resin material for primary molding. Accordingly, the seal member 16 is positioned relative to the metal mold for primary molding 32.

After the metal mold for primary molding 32 is filled with the molten resin material for primary molding, the molten resin material for primary molding is then cooled and hardened. Once the molten resin material for primary molding hardens, the molding of the primary molded portion 11 is complete and the inner peripheral surface and rear end surface of the seal member 16 are formed as a single body with the outer periphery of the primary molded portion 11 in a state of liquid-tight areal contact. Also, the sensor 22 and the front end portion of the wire harness 25 are formed as a single body in a state of being embedded into the primary molded portion 11, and the exposed portion 22E of the sensor 22 is exposed from the upper surface of the front end portion of the primary molded portion 11. Thus, the primary molded module 30 is produced.

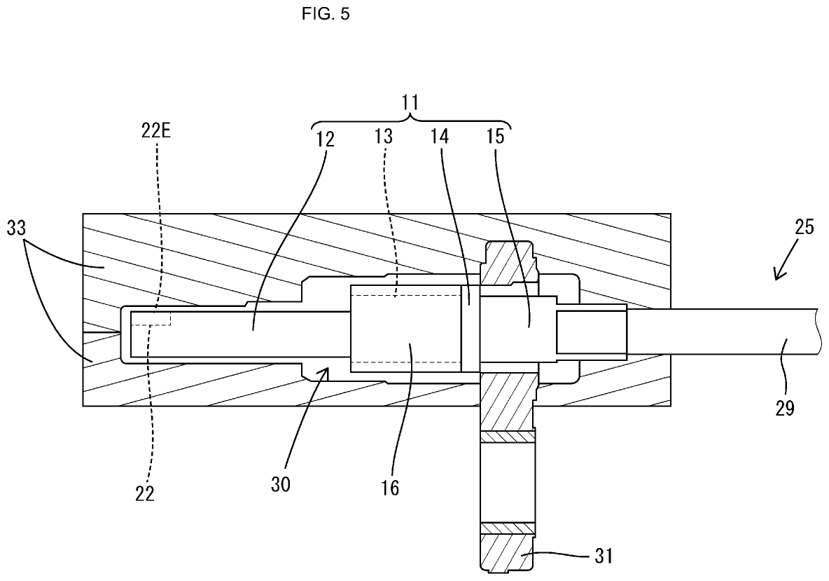

Afterwards, as shown in FIG. 5, the primary molded module 30 and the bracket 31 are set into the metal mold for secondary molding 33. In this state, a molten polyamide material that contains glass (hereinafter referred to as “molten resin material for secondary molding”), which is the material from which the secondary molded portion 17 is made, is injected into the metal mold for secondary molding 33. The temperature of the molten resin material for secondary molding (polyamide resin that contains glass) to be injected into the metal mold is higher than 240° C., which is higher than the melting point for urethane resin from which the seal member 16 is made.

Due to this difference in temperature, the outer peripheral surface and the front end surface of the seal member 16 that are in contact with the molten resin material for secondary molding melts, and the melted portions of the seal member 16 melt together with and form a single body with the molten resin material for secondary molding. Note that the entire region of the inner peripheral surface and the rear end surface of the seal member 16 do not melt because said surfaces are in areal contact with the cooled primary molded portion 11. Accordingly, the seal member 16 becoming displaced relative to the primary molded portion 11 is not a concern.

After the metal mold for secondary molding 33 is filled with the molten resin material for secondary molding, the molten resin material for secondary molding is cooled and hardened. Once the molten resin material for secondary molding hardens, the molding of the secondary molded portion 17 is complete and the outer peripheral surface and the front end surface of the seal member 16 are formed as a single body with the inner periphery of the secondary molded portion 17 in a state of liquid-tight areal contact. The primary molded module 30 includes the seal member 16 and the primary molded portion 11, and is formed as a single body in a state of being embedded in the secondary molded portion 17. Also, the exposed portion 22E of the sensor 22 that is exposed from the upper surface of the front end portion of the primary molded portion 11 is covered by the secondary molded portion 17 in a state of areal contact. Thus, the production of the resin molded article M is complete.

In the primary molded module 30, the exposed portion 22E of the sensor 22 is exposed from the outer surface of the primary molded portion 11, but the exposed portion 22E of the sensor 22 is covered by the secondary molded portion 17. The front end portion of the secondary molded portion 17 has a bottomed tubular shape and is closed off by the front wall portion 18, and therefore the position at which the interface between the inner periphery of the rear end portion of the secondary molded portion 17 and the outer periphery of the primary molded portion 11 faces the outside of the resin molded article M is a liquid-penetrable opening through which water can enter from the outside of the resin molded article M. This liquid-penetrable opening is positioned rearward of the exposed portion 22E of the sensor 22.

As a preventative measure, the seal member 16 is arranged in the region rearward of the exposed portion 22E of the sensor 22, where the seal member 16 liquid-tightly seals the gap between the inner peripheral surface of the secondary molded portion 17 and the outer peripheral surface of the primary molded portion 11. The seal member 16 has a round, tubular shape that has a predetermined size in the front-rear direction (the direction from the liquid-penetrable opening to the exposed portion 22E of the sensor 22). Accordingly, the region of areal contact (the region of liquid-tightness) in the front-rear direction between the outer peripheral surface of the seal member 16 and the inner peripheral surface of the secondary molded portion 17, and the region of areal contact (the region of liquid-tightness) in the front-rear direction between the inner peripheral surface of the seal member 16 and the outer peripheral surface of the primary molded portion 11 are maintained for a long period of time. Thus, the seal member 16 makes it possible to reliably inhibit water from entering into the exposed portion 22E of the sensor 22 from the outside of the resin molded article M.

The resin molded article M of the first embodiment as described above includes the primary molded portion 11 that is made from a synthetic resin material, the coated wires 26 of which the front end portions are embedded in the primary molded portion 11, the sensor 22, the seal member 16, and the secondary molded portion 17. The sensor 22 is connected to the front end portions of the coated wires 26 in the primary molded portion 11, and is arranged so as to be partially exposed from the outer surface of the primary molded portion 11. The seal member 16 has a tubular shape and is in liquid-tight areal contact with the region of the outer periphery of the primary molded portion 11 that is rearward of the exposed portion 22E of the sensor 22. The secondary molded portion 17 is in liquid-tight areal contact with the outer periphery of the seal member 16, and also encases at least the entire region of the primary molded portion 11 that is forward of the seal member 16.

The seal member 16 seals the gap between the outer periphery of the primary molded portion 11 and the inner periphery of the secondary molded portion 17 in a liquid-tight state, and because the seal member 16 has a tubular shape that is long in the front-rear direction, the sealed region between the primary molded portion 11 and the seal member 16, and the sealed region between the seal member 16 and the secondary molded member 17, are maintained for a long time in the front-rear direction. Accordingly, this configuration has superior sealing performance and can reliably inhibit liquid from entering into the exposed portion 22E of the sensor 22.

Also, the seal member 16 is made from a synthetic resin material that has a lower melting point than that of the synthetic resin material from which the primary molded portion 11 is made. Thus, in the primary molding process in which the metal mold for primary molding 32 is used, the inner peripheral surface of the seal member 16 is melted by the heat of the molten resin material for primary molding, and the inner peripheral surface of the melted seal member 16 is welded to the outer peripheral surface of the primary molded portion 11. Accordingly, it is possible to simultaneously execute the process of molding the primary molded portion 11 and the process of attaching the seal member 16 to the primary molded portion 11 in areal contact.

Also, the seal member 16 is made from a synthetic resin material that has a lower melting point than the synthetic resin material from which the secondary molded portion 17 is made. Thus, in the secondary molding process in which the metal mold for secondary molding 33 is used, the outer peripheral surface of the seal member 16 is melted by the heat of the molten resin material for secondary molding, and the outer peripheral surface of the melted seal member 16 is welded to the inner peripheral surface of the secondary molded portion 17. Accordingly, it is possible to simultaneously execute the process of molding the secondary molded portion 17 and the process of attaching the seal member 16 to the secondary molded portion 17 areal contact.

Also, the primary molded portion 11 and the secondary molded portion 17 of the resin molded article M of the first embodiment are made from the same material (polyamide resin that contains glass), but if the outside temperature suddenly changes, there is concern that the difference in temperature between the primary molded portion 11 and the secondary molded portion 17 may cause the outer periphery of the primary molded portion 11 and the inner periphery of the secondary molded portion 17 to become positionally displaced in the front-rear direction, and as a result cause damage such as shearing to the seal member 16. Here, the seal member 16 of the present embodiment is made of urethane resin. Urethane resin has a comparatively high toughness, and therefore the seal member 16 becoming damaged is not a concern.

### Other Embodiments

The present disclosure is not limited to the embodiments described according to the above description and the drawings, and for example, embodiments such as the following are also included within the technical scope of the present disclosure.

In the first embodiment described above, the seal member is made from a synthetic resin material that has a lower melting point than that of the primary molded portion, but configurations are also possible in which the material of the seal member is synthetic resin material that has the same melting point as that of the primary molded portion, or has a higher melting point than that of the primary molded portion.

In the first embodiment described above, the seal member is made from a synthetic resin material that has a lower melting point than that of the secondary molded portion, but configurations are also possible in which the material of the seal member is a synthetic resin material that has the same melting point as that of the secondary molded portion, or has a higher melting point than that of the secondary molded portion.

In the first embodiment described above, the seal member is made of urethane resin, but a configuration is also possible in which the seal member is made of a synthetic resin other than urethane resin.

In the first embodiment described above, the seal member is made of a synthetic resin, but there is no limitation thereto and a configuration is also possible in which the seal member is made of a metal.

In the first embodiment described above, the primary molded portion is made of a polyamide resin (PA) that contains glass, but a configuration is also possible in which the primary molded portion is made of a synthetic resin material other than a polyamide resin that contains glass.

In the first embodiment described above, the secondary molded portion is made from a polyamide resin (PA) that contains glass, but a configuration is also possible in which the secondary molded portion is made of a synthetic resin material other than a polyamide resin that contains glass.

In the first embodiment described above, the primary molded portion and the secondary molded portion are made of the same material, but a configuration is also possible in which the primary molded portion and the secondary molded portion are made from different materials.

1. A resin molded article comprising:
a primary molded portion made from a synthetic resin material;
a wire of which a front end portion is embedded in the primary molded portion;
an electronic component that is connected to the front end portion of the wire in the primary molded portion, and is arranged such that the electronic component is partially exposed from an outer surface of the primary molded portion;
a seal member that has a tubular shape and is in liquid-tight areal contact with a region of an outer periphery of the primary molded portion that is rearward of the exposed portion of the electronic component; and
a secondary molded portion that is in liquid-tight areal contact with an outer periphery of the seal member, and encases at least an entire region of the primary molded portion that is forward of the seal member.

2. The resin molded article according to claim 1, wherein the seal member is made from a synthetic resin material that has a lower melting point than that of the synthetic resin material from which the primary molded portion is made.

3. The resin molded article according to claim 1, wherein the seal member is made of a synthetic resin material that has a lower melting point than that of the synthetic resin material from which the secondary molded portion is made.

4. The resin molded article according to claim 1, wherein the seal member is made of a urethane resin.

5. The resin molded article according to claim 2, wherein the seal member is made of a synthetic resin material that has a lower melting point than that of the synthetic resin material from which the secondary molded portion is made.

6. The resin molded article according to claim 2, wherein the seal member is made of a urethane resin.

7. The resin molded article according to claim 3, wherein the seal member is made of a urethane resin.
